(19) United States
(12) Patent Application Publication
(10) Pub. No.: US 2013/0054400 A1
(43) Pub. Date: Feb. 28, 2013

(54) MANAGEMENT OF DIRECT SALES ACTIVITIES ON NETWORKED MOBILE COMPUTING DEVICES

(71) Applicant: Jade Makani Roberge Charles, San Diego, CA (US)

(72) Inventor: Jade Makani Roberge Charles, San Diego, CA (US)

(21) Appl. No.: 13/406,497

(22) Filed: Feb. 27, 2012

Related U.S. Application Data
(63) Continuation of application No. 13/223,268, filed on Aug. 31, 2011.

(51) Int. Cl. G06Q 30/06

(52) U.S. Cl. 705/26.1

(57) ABSTRACT

A method on a mobile computer for managing sales activities for a first user over a communications network is disclosed. The method includes accepting sales transaction data via an application on a mobile computer, wherein the mobile phone transmits the sales transaction data to a central server via the communications network and accepting recruit enrollment data via the application, wherein the mobile computer transmits the recruit enrollment data to the central server via the communications network. The method further includes receiving by the mobile computer from the central server, via the communications network, aggregate data pertaining to sales effectuated by the first user and pertaining to sales effectuated by recruits of the first user and displaying the aggregate data on the mobile computer for the first user.

This patent application is a continuation of, and claims priority to, U.S. patent application Ser. No. 13/223,268, filed Aug. 13, 2011, and entitled “Management of Direct Sales Activities on Networked Mobile Computing Devices.” U.S. patent application Ser. No. 13/223,268 is hereby incorporated by reference in its entirety.

### BACKGROUND OF THE INVENTION

1. Field of the Invention

The present invention relates to the field of sales, advertising and marketing and, more specifically, the present invention relates to the field of scalable systems for managing direct sales activities on electronic devices.

2. Description of the Related Art

The present invention relates to direct sales activities of all types. Direct selling is the marketing and selling of products directly to consumers away from a fixed retail location. Modern direct selling includes sales made through a party plan, one-on-one demonstrations, and other personal contact arrangements, as well as internet sales. Thus, direct sales include direct personal presentation, demonstration, and sale of products and services to consumers, usually in their homes or at their jobs. One form of direct selling includes multi-level marketing (MLM), which is a marketing strategy in which a sales force is compensated not only for product sales they personally generate, but also for the product sales of others they recruit, creating a downstream of distributors and a hierarchy of multiple levels of compensation.

Salesmen involved in direct selling are usually compensated based on a commission basis or similar arrangement. Predefined sales milestones are also used to delineate when a salesman is awarded a bonus or award. As such, active salesmen constantly stay abreast of various performance indicators, such as the amount of their cumulative sales, the amount of their recruit's cumulative sales, proximity to the next milestone, the status of prospective recruits or prospective customers, etc.

In the past, sales performance indicators were calculated and disseminated via paper. As individuals were recruited and sales transactions occurred, the related information was tallied at a central location and then disseminated on a periodic basis, such as in hard copy, to each salesman. One problem with the conventional approach, however, is that a salesman is not aware of the current status of his performance indicators in between periodic reports. This reduces the ability of the salesman to optimize his activities in between reports, so as to attain his goals or milestones. Another problem with the conventional approach is that sales and recruitment transaction data are transcribed, recorded and processed with the aid of individuals. This makes the resulting data vulnerable to human error and therefore lacking in high levels of accuracy.

Furthermore, the conventional recruiting process involves meeting and communicating with prospective recruits, following up with the recruits, and handling the process of enrolling new recruits in the sales program. In addition, the conventional sales process involves communicating with prospective buyers, showing the products for sale, handling the sales transaction and arranging the shipping or delivery of the products. All of the aforementioned sales activities involve time-consuming tasks including travel, personal meetings, data entry and paperwork. With the increasing demands on individuals' time in modern society, the time demands of conventional direct sales act as a barrier to entry for many individuals today.

Therefore, what is needed is a system and method for improving the problems with the prior art, and more particularly for a more efficient method and system for facilitating direct sales activities.

### BRIEF SUMMARY OF THE INVENTION

In one embodiment, the present invention discloses a method on a mobile computer for managing sales activities for a first user over a communications network. The method includes accepting sales transaction data via an application on a mobile computer, wherein the mobile phone transmits the sales transaction data to a central server via the communications network and accepting recruit enrollment data via the application, wherein the mobile computer transmits the recruit enrollment data to the central server via the communications network. The method further includes receiving by the mobile computer from the central server, via the communications network, aggregate data pertaining to sales effectuated by the first user and pertaining to sales effectuated by recruits of the first user and displaying the aggregate data on the mobile computer for the first user.

In another embodiment, the present invention discloses a method on a server for managing sales activities for a first user over a communications network. The method includes receiving sales transaction data from a mobile computer of the first user via the communications network, and receiving recruit enrollment data from the mobile computer via the communications network. The method further includes processing the sales transaction data and the recruit enrollment data to generate aggregate data pertaining to sales effectuated by the first user and pertaining to sales effectuated by recruits of the first user and transmitting the aggregate data to the mobile computer of the first user via the communications network.

In another embodiment, the present invention discloses a system for managing sales activities for a first user over a communications network. The system includes a mobile computer including an application for accepting sales transaction data and transmitting the sales transaction data to a central server via the communications network and an application for accepting recruit enrollment data and transmitting the recruit enrollment data to the central server via the communications network. The system further includes a central server configured for receiving sales transaction data and recruit enrollment data from the mobile computer, processing the sales transaction data and the recruit enrollment data to generate aggregate data pertaining to sales effectuated by the first user and pertaining to sales effectuated by recruits of the first user, and transmitting the aggregate data to the mobile computer of the first user via the communications network.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a block diagram illustrating a network architecture of a system for providing management of sales activities and data over a communications network, in accordance with one embodiment of the present invention.

FIG. 2 is a block diagram showing the various data that is entered, stored, processed and managed according to one embodiment of the present invention.

FIG. 3 is a block diagram showing advertising and promotion methods according to one embodiment of the present invention.

### DETAILED DESCRIPTION OF THE INVENTION

The present invention improves upon the problems with the prior art by providing a more efficient method and system for managing direct sales activities, recruitment/sales data and related information on networked computing devices, both mobile and non-mobile. In one embodiment, the present invention provides a mobile computing device, wherein salesmen may effectuate product sales, enroll recruits and view sales performance indicators. This allows salesmen to perform basic sales and recruitment activities while on the road and away from the home or the office, thereby facilitating sales activities and keeping the salesmen posted on sales performance indicators while on the go.

Additionally, the present invention provides a scalable and easy-to-use system for allowing sales participants and administrators of the system to log onto a central server/repository to manage and view sales data and sales performance indicators. Data can be analyzed and viewed in aggregate, by demographic data, by salesman or recruit, by location, etc. The present invention further improves over the prior art by providing a centralized system for gathering and managing various types of data associated with direct sales activities, including multi-level marketing (MLM) activities.

Finally, the present invention improves upon the prior art by providing technologically advanced methods for advertising and promotion in a direct sales environment using mobile technology. The present invention employs the use of push technology to push promotions and ads to customers and salesmen. This is advantageous as it facilitates commerce over a communications network and speeds up the process of fielding promotions and ads to a large sales force.

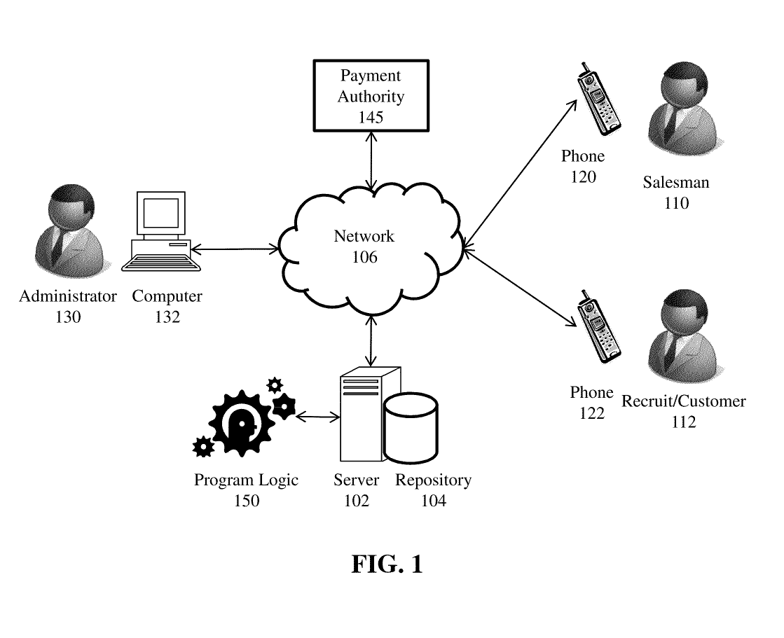

Referring now to the drawing figures in which like reference designators refer to like elements, there is shown in FIG. 1 an illustration of a block diagram showing the network architecture of a system and method for providing management of direct sales activities and data over a communications network in accordance with the principles of the present invention. The most prominent element of FIG. 1 is the server 102 associated with repository or database 104 and further coupled with network 106, which can be a circuit switched network, such as the Public Service Telephone Network or a packet switched network such as the Internet or the World Wide Web. Server 102 is a central controller or operator for the functionality that executes on computers 120, 122 and 132, namely, the processing of sales and enrollment transactions, as well as the processing of aggregate sales data, all of which are provided to the users 110, 112 and 130, wherein the provision of the foregoing services and data facilitates the performance of direct sales activities. Aggregate sales data, or aggregate data pertaining to sales, pertains to an aggregation, or a cumulative sum, for example, of all sales that are effectuated by a single salesman, by one of the salesman's recruits, by all of the salesman's recruits, any combination of the above, or the like.

FIG. 1 further includes mobile computers 120 and 122, which may be smart phones, mobile phones, tablet computers, handheld computers, laptops, or the like. Mobile computers 120 and 122 correspond to a salesman 110 and a recruit or customer 112 of the salesman 112. A salesman 110, also known as a distributor, is a member of a direct sales force who sells products to customers and recruits others to do the same. A salesman's recruits may also be known as distributors. A salesman 110 receives compensation for his own product sales, as well as the sales of his recruits, often via a commission. A customer simply refers to a person to whom a salesmen sales products or services. Computer 132 corresponds to an administrator 130, who may perform supervisory or administrative tasks on server 102. Administrator 130 may, for example, set sales milestones for the users 110, 112. Computer 132 may be a mobile computer, a desktop computer, a common computer terminal or the like.

FIG. 1 further shows that server 102 includes a database or repository 104, which may be a relational database comprising a Structured Query Language (SQL) database stored in a SQL server. Client computers 120, 122 and 132 may also each include their own database. The repository 104 serves data from a database, which is a repository for data used by server 102 and the client computers during the course of operation of the invention.

The database 104 may include a user record for each salesman 110 and recruit or customer 112. A user record may include: contact/identifying information for the user, contact/identifying information for the participant that recruited the user (if any), information pertaining to sales attributed to the user, contact/identifying information for recruits of the user, information pertaining to recruitment activity of the user, information pertaining to sales attributed to recruits of the user, electronic payment information for the user, information pertaining to calls made by the user, information pertaining to the purchases made by the user, etc. Recruit enrollment data includes any data that is entered into a user record for a recruit or customer 112 when the recruit or customer is recruited and enrolled by a salesman 112.

Sales transaction data, for example, may be stored in the database 104 and associated with a record for the user initiating the sale and/or the customer purchasing products or services. Sales transaction data may include one or more product identifiers, one or more product amounts, buyer contact/identifying information, product shipping information and electronic payment information. In one embodiment, electronic payment information may comprise buyer contact/identifying information, credit card data garnered from a credit or debit card and authentication information. Recruitment activity data, for example, may also be stored in the database 104 and associated with a record for the user performing the recruitment. Recruitment activity data may include contact/identifying information for prospective and active recruits, updates on follow up communications with prospective and active recruits, information pertaining to phone calls with prospective and active recruits, and status information for prospective and active recruits.

The database 104 may also include a record for each administrator 130. A record for an administrator may include: commission data that defines how salesmen are compensated for their own sales, commission data that defines how salesmen are compensated for the sales of their recruits, milestone data that defines thresholds that result in an award, personal sales goals, group sales goals, etc.

FIG. 1 shows an embodiment of the present invention wherein networked computing devices 120, 122 and 132 interact with server 102 and repository 104 over the network 106. Server 102 includes a software engine that delivers applications, data, program code and other information to networked computing devices 120, 122 and 132. The software engine of server 102 may perform other processes such as audio and/or video streaming or other standards for transferring multimedia data in a stream of packets that are interpreted and rendered by a software application as the packets arrive. It should be noted that although FIG. 1 shows only three networked computing devices 120, 122 and 132, the system of the present invention supports any number of networked computing devices connected via network 106.

In one embodiment of the present invention, the application provided by the server 102 of FIG. 1 is a client-server application having a client portion that resides on a client computer (i.e., 120, 122 and 132) and a server application that resides on server 102. For example, the application can be a web interface that is accessed by a client computer via network 106. The application served by server 102 may be written using any of the following technologies: CSS (Cascading Style Sheets), DOM (Document Object Model), JavaScript, XPCOM (Cross-Platform Component Object Model), XPConnect, XPI (Cross-Platform Installer), XUL (XML User Interface Language).

Server 102 includes program logic 150 comprising computer source code, scripting language code or interpreted language code that is compiled to produce computer instructions that perform various functions of the present invention. In one embodiment of the present invention, the program logic is a scripting language such as ECMAScript, CSS, XML (Extensible Markup Language), XSLT (Extensible Style-sheet Language Transformations), Javascript, AJAX (Asynchronous JavaScript and XML), XUL, JSP, PHP, and ASP (Active Server Pages). Program logic 150 may reside on a client computer, the server 102 or any combination of the two.

Note that although server 102 is shown as a single and independent entity, in one embodiment of the present invention, the functions of server 102 may be integrated with another entity, such as one of the client computers or payment authority 145. Further, server 102 and its functionality, according to a preferred embodiment of the present invention, can be realized in a centralized fashion in one computer system, or in a distributed fashion where different elements are spread across several interconnected computer systems.

The network architecture of FIG. 1 in accordance with the principles of the present invention may give rise to various revenue-generating arrangements. The users 110, 112 may, for example, sale products via the application of the present invention and recruit others to do the same. The users 110, 112 may also, for example, pay an ongoing or per-transaction fee to the operators of server 102 in exchange for the services provided by server 102.

FIG. 1 also shows a payment authority 145 to effectuate payments by salesman 110 and/or recruit/customer 112 for products, services or the like. In the course of a sales transaction, the program logic 150 may interface with payment authority 145 to effectuate payment. In one embodiment of the present invention, the payment authority 145 is a payment gateway, which is an e-commerce Application Service Provider (ASP) service that authorizes payments for individuals, e-businesses, online retailers, or traditional brick and mortar businesses. The payment authority 145 may accept payment via the use of credit cards, charge cards, bank cards, gift cards, account cards, etc.

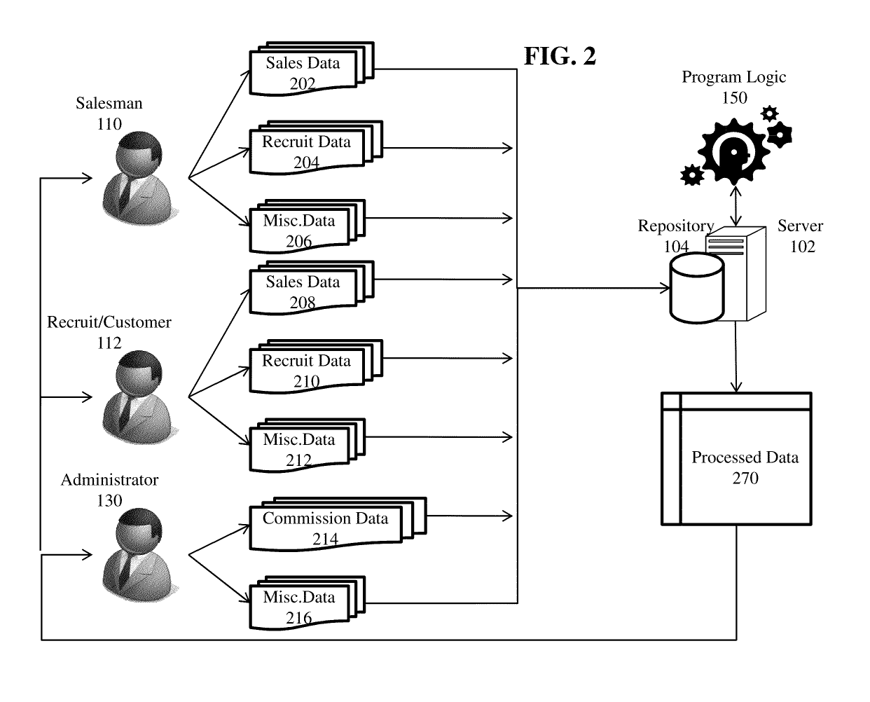

FIG. 2 is a block diagram showing the various data that is entered, stored, processed and managed according to one embodiment of the present invention. FIG. 2 shows that salesman 110 may enter various data sets into repository 104 for processing and management by program logic 150 on server 102. Salesman 110 may enter sales transaction data 202, which pertains to sales of products effectuated by the salesman 110. Salesman 110 may also enter recruitment activity data 204, which pertains to recruitment of others to participate in the sales force. Salesman 110 may also enable the entering of other miscellaneous data 204, such as information associated with telephone calls initiated by the salesman, social media updates provided by the salesman, text messages entered by the salesman, status messages entered by the salesman, audio/video/images entered by the salesman and self-defined sales goals of the salesman.

Data sets 202, 204 and 206 may be entered into repository 104 by the salesman 110 via its client computer 120, using a mobile app or a similar means. Note that data sets 202, 204 and 206 entered into repository 104 are associated with the user record for salesman 110. To the extent that certain information within data sets 202, 204 and 206 is associated with another user, such as recruitment activity data being associated with recruit 112, the aforementioned data may also be associated with the user record for recruit 112.

FIG. 2 also shows that recruit 112 may enter various data sets into repository 104 for processing and management by program logic 150 on server 102. Recruit 112 may enter sales transaction data 208, which pertains to sales of products effectuated by the recruit 112, and recruitment activity data 210, which pertains to recruitment of others to participate in the sales force. Recruit 112 may also enable the entering of other miscellaneous data 212, such as information associated with telephone calls initiated by the recruit, etc.

Data sets 208, 210 and 212 may be entered into repository 104 by the recruit 112 via its client computer 122, using a mobile app or a similar means. Note that data sets 208, 210 and 212 entered into repository 104 are associated with the user record for recruit 112. To the extent that certain information within data sets 208, 210 and 212 is associated with another user, such as any sales, which are inherently related to salesman 110, since he recruited recruit 112, the aforementioned data may also be associated with the user record for salesman 110.

FIG. 2 further shows that administrator 130 may enter various data sets into repository 104 for processing and management by program logic 150 on server 102. Administrator 130 may enter commission data 214 or sales award milestone data pertaining to one or more users. Administrator 130 may also enable the entering of other miscellaneous data 216, such as information associated with telephone calls initiated by the administrator, etc. Data sets 214 and 216 may be entered into repository 104 by the administrator 130 via its client computer 132. Note that data sets 214 and 216 entered into repository 104 are associated with the user record to which the data pertains.

The data sets entered by the various parties may be processed by program logic 150 on server 102 and presented for viewing to administrator 130, salesman 110 and recruit 112 as processed data 270 via network 106. Processed data 270 may be processed so as to provide compilations or aggregations of the data sets entered by various users into repository 104, such as cumulative data and trend data. For example, processed data 270 may display cumulative sales for each user (by dollar amount and item volume), cumulative sales for groups of recruits recruited by a user, cumulative sales for user or group as it corresponds to certain time intervals or shown over a period of time, total number of recruits for a user, total number of recruits for a user's recruits, projected sales for a user and for the user's recruits, etc.

In one embodiment, the processed data 270 includes commission information for each salesman 110, recruit or customer 112. The commission information may include the past, current or future amount of commission(s) earned by each salesman/recruit/customer according to the formula for calculating a commission, which resides in the data 214 entered by the administrator 130. The formula for calculating a commission may comprise, for example, a certain percentage of gross or net sales of an individual and a certain percentage of gross or net sales of an individual's recruits. The formula for calculating a commission may also take other data into account, such as volume of sales, speed of sales, etc. Processed data 270 may further be processed using any statistical technique to aid interpretation of data. Program logic 150 may also provide for differing views of the processed data 270.

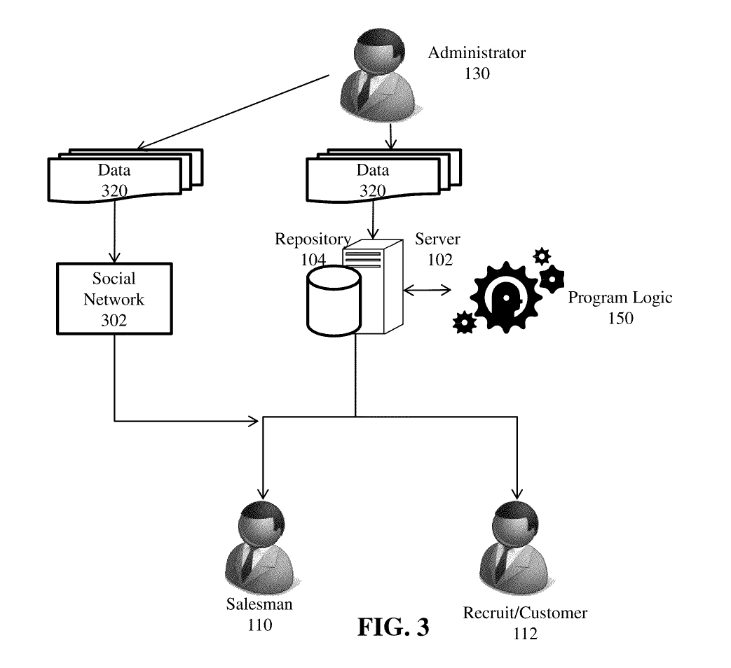

FIG. 3 is a block diagram showing advertising and promotion methods according to one embodiment of the present invention. The block diagram of FIG. 3 illustrates the process of advanced methods of issuing promotions and ads in a direct sales environment.

FIG. 3 describes a process wherein administrator 130 generates an ad or promotion (hereinafter referred to as an “offer”) and the server 102 disseminates it to salesman 110 and recruit or customer 112 via push technology. Push technology, or server push, describes a style of Internet-based communication where the ad or promotion, created by administrator 130, is transmitted by the server 102 to clients. Push technology is contrasted with pull technology, where the request for the transmission of information is initiated by the receiver or client. Examples of push technology include HTTP server push, a pushlet, long polling and Flash XMLSocket relays. Note the invention also supports ads or promotions being generated by salesman 110 or customer 112 and pushed to others.

FIG. 3 shows that in one embodiment, administrator 130 generates an offer, encapsulated in data packet 320, and sends it to the server 102. The data packet 320 may include a description of goods being promoted, a percentage discount on goods, a price for goods, a rebate on goods, still images, video, audio, a time limit for the promotion or sale, or the like. The data packet 320 may also include data pertaining to the target for the offer, such as a location, a region, a time period, demographic data describing individuals to which the offer is directed and/or specific names or address of the individuals to which the offer is directed.

The generated data packet 320 is then provided to server 102, wherein logic 150 of server 102 processes the data packet and determines how to implement it. For example, the logic 150 of server 102 may determine to whom the corresponding offer is transmitted, based on the target data specified in the data packet 320. In another example, the logic 150 of server 102 determines when and for how long the offer is valid, based on information specified in the data packet 320. Once processed, the server 102 transmits the corresponding offer to the intended recipients, such as users 110 and 112, via push technology at the specified time. Specifically, server 102 transmits the offer to the mobile computers 120 and 122 of the users 110 and 112, respectively.

In one embodiment, the generated data packet 320 is provided to a third party social network 302 via the web 106, which processes the data packet and determines how to implement it, similar to the implementation of server 102. Once processed, the social network 302 transmits the corresponding offer to the intended recipients, such as users 110 and 112. Specifically, the social network 302 transmits the offer to the mobile computers 120 and 122 of the users 110 and 112.

In yet another embodiment, the third party social network 302 transmits offers specified in the data packet 320 based on a location based service. A location based service is an information or entertainment service, accessible with mobile devices through the mobile network and utilizing the ability to make use of the geographical position of the mobile device. In this embodiment, the corresponding data packet 320 may specify that an offer shall be transmitted solely to users that are located within a specified geographical area. Consequently, the third party social network 302 transmits the offer of the data packet 320 based on the location of the users 110 and 112, as provided by the location based service.

In yet another embodiment, the offer provided to the users 110 and 112 by server 102 may be valid solely for a specified period of time, to users within a certain geographical area and/or after a certain number of purchases of the offer have occurred. The interface of the mobile computers 120 and 122 of the users 110 and 112 may display a timer that counts down the remaining time of the offer. Further, as users take advantage of the offer and purchase the advertised goods, the logic 150 of server 102 logs the purchase information and sends the purchase information to the mobile computers 120 and 122 of the users 110 and 112. Consequently, the interface of the mobile computers 120 and 122 of the users 110 and 112 display a counter that counts the number of purchasers of the offer. As such, the displayed counter indicates how many additional sales must occur before the offer takes effect. Also, a location based service may be used to determine the location of the mobile computer of a user and therefore the eligibility of the user for the offer. For example, the mobile computer 120 of salesman 110 may provide the location of the salesman to the server 102. If the logic 150 of server 102 determines that the salesman 110 is within the specified geographic area, then the server 102 transmits deems the salesman 110 as eligible for the offer.

In one embodiment of the present invention, the offer generated by the administrator 130 and encapsulated in data packet 320 comprises an offer to sell one or more products at a given price, wherein the given price decreases as more buyers purchase the one or more products. In this embodiment, the administrator 130 may set the product or products of the offer, the sliding pricing scale, the time frame for the offer, etc. In this embodiment, upon purchase of the one or products by a buyer, such as user 112, the buyer's credit card is authorized for the initial given price of the one or more products of the offer. Upon expiration of the time frame of the offer, user 112's credit card is billed the price of the one or more products at the time of expiration, wherein the initial given price may have decreased due to additional buyers.

In another embodiment of the present invention, an administrator 130 may define (location, GPS coordinates, address, host name, time/date, description, etc.) a “challenge party” or other social gathering event for the purpose of selling subscriptions or products. Users 110 and 112 may then receive notices of the event via push technology on their mobile computers 120 and 122. Users 110 and 112 may attend the event and use their mobile computers to “check in” using location based services. The data associated with the “check in” of users 110 and 112 may then be transmitted to social network 302 (by server 102 and/or mobile computers 120, 122), which may then be further transmitted and/or displayed by the social network 302. Users 110 and 122, and other participants, such as the host of the event, may receive rewards based on the “check ins” that occur at the event.

Consistent with the embodiments described herein, the aforementioned actions performed by elements 132, 102, 120, 122 may be implemented in a computing device. Any suitable combination of hardware, software, or firmware may be used to implement the computing device. A system consistent with an embodiment of the invention may include a plurality of computing devices. In a basic configuration, a computing device may include at least one processing unit and a system memory. Depending on the configuration and type of computing device, system memory may comprise, but is not limited to, volatile (e.g. random access memory (RAM)), non-volatile (e.g. read-only memory (ROM)), flash memory, or any combination or memory. System memory may include an operating system, and one or more programming modules. An operating system, for example, may be suitable for controlling a computing device's operation. In one embodiment, programming modules may include, for example, a program module that performs the functions of program logic 150.

A computing device may have additional features or functionality. For example, a computing device may also include additional data storage devices (removable and/or non-removable) such as, for example, magnetic disks, optical disks, or tape. Such additional storage may be removable storage and a non-removable storage. Computer storage media may include volatile and nonvolatile, removable and non-removable media implemented in any method or technology for storage of information, such as computer readable instructions, data structures, program modules, or other data. System memory, removable storage, and non-removable storage are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by a computing device. Any such computer storage media may be part of the computing device. A computing device may also have input device(s) such as a keyboard, a mouse, a pen, a sound input device, a camera, a touch input device, etc. Output device(s) such as a display, speakers, a printer, etc. may also be included. The aforementioned devices are only examples, and other devices may be added or substituted.

The computing device may also contain a communication connection that may allow the device to communicate with other computing devices, such as over a network in a distributed computing environment, for example, an intranet or the Internet. The communication connection is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

1. A method performed by a mobile application executing on a mobile computer of a first user, the method for managing sales activities for the first user over a communications network, comprising:
accepting sales transaction data entered by the first user via a graphical user interface of the mobile application on the mobile computer, responsive to a second user providing the sales transaction data to the first user, wherein the sales transaction data comprises at least one product identifier, an amount of product and electronic payment information for the second user, and wherein the mobile computer transmits the sales transaction data to a central server via the communications network;
accepting recruit enrollment data entered by the first user via the graphical user interface of the mobile application, responsive to the second user providing the recruit enrollment data to the first user, wherein recruitment enrollment data includes at least contact information for the second user, and wherein the mobile computer transmits the recruit enrollment data to the central server via the communications network;
transmitting, by the mobile computer, an authentication request for the first user to the central server via the communications network, so as to associate the sales transaction data and the recruit enrollment data with a record of the first user;
receiving by the mobile computer from the central server, via the communications network, aggregate data representing cumulative sales effectuated by the first user and representing cumulative sales effectuated by the second user; and
displaying the aggregate data on the graphical user interface of the mobile application of the mobile computer for the first user.

2. The method of claim 1, wherein sales transaction data includes at least one or more product identifiers, buyer contact information and electronic payment information.

3. The method of claim 2, wherein recruit enrollment data includes contact information of a recruit and electronic payment information of the recruit.

4. The method of claim 3, wherein aggregate data pertaining to sales effectuated by the first user comprises cumulative sales effectuated by the first user.

5. The method of claim 4, wherein aggregate data pertaining to sales effectuated by recruits of the first user comprises cumulative sales effectuated by recruits of the first user.

6. The method of claim 1, further comprising:
receiving by the mobile computer from the central server, via the communications network, commission information of the first user based on the sales effectuated by the first user and the sales effectuated by recruits of the first user.

7. A method on a server for managing sales activities for a first user over a communications network, comprising:
receiving, via the communications network, sales transaction data entered by the first user into a mobile computer of the first user, responsive to a second user providing the sales transaction data to the first user, wherein the sales transaction data comprises at least one product identifier, an amount of product and electronic payment information for the second user;
receiving, via the communications network, recruit enrollment data entered by the first user into the mobile computer of the first user, responsive to the second user providing the recruit enrollment data to the first user, wherein recruit enrollment data includes contact information of the second user and electronic payment information of the second user;
receiving, via the communications network, an authentication request for the first user and associating the sales transaction data and the recruit enrollment data with a record of the first user;
receiving, via the communications network, sales transaction data entered by the second user into from a mobile computer of the second user;
associating the sales transaction data from the second user with the record of the first user;
generating aggregate data representing cumulative sales effectuated by the first user and representing cumulative sales effectuated by the second user; and
transmitting, via the communications network, the aggregate data to the mobile computer of the first user.

8. The method of claim 7, wherein sales transaction data includes at least one or more product identifiers, buyer contact information and electronic payment information.

9. The method of claim 8, wherein recruit enrollment data includes a description of communication activity with the second user, including a log of telephone calls to the second user.

10. The method of claim 9, wherein aggregate data pertaining to sales effectuated by the first user comprises cumulative sales effectuated by the first user.

11. The method of claim 10, wherein aggregate data pertaining to sales effectuated by recruits of the first user comprises cumulative sales effectuated by recruits of the first user.

12. The method of claim 1, further comprising:
generating commission information of the first user based on the sales effectuated by the first user and the sales effectuated by recruits of the first user; and
transmitting the commission data to the mobile computer of the first user via the communications network.

13. A system for managing sales activities for a first user over a communications network, comprising:
a memory storage;
a network connection device; and
a processing unit coupled to the memory storage, wherein the processing unit is configured for:
receiving, via the communications network, sales transaction data entered by the first user into a mobile computer of the first user, responsive to a second user providing the sales transaction data to the first user, wherein the sales transaction data comprises at least one product identifier, an amount of product and electronic payment information for the second user;
receiving, via the communications network, recruit enrollment data entered by the first user into the mobile computer of the first user, responsive to the second user providing the recruit enrollment data to the first user, wherein recruit enrollment data includes contact information of the second user;
receiving, via the communications network, an authentication request for the first user and associating the sales transaction data and the recruit enrollment data with a record of the first user;
receiving, via the communications network, sales transaction data entered by the second user into a mobile computer of the second user;
associating the sales transaction data from the second user with the record of the first user;
receiving, via the communications network, social media update data from the mobile computer of the first user, wherein the social media update data includes at least text and an image, and transmitting, via the communications network, the social media update data to the mobile computer of the second user;
generating aggregate data representing cumulative sales effectuated by the first user and representing cumulative sales effectuated by the second user; and
transmitting, via the communications network, the aggregate data to the mobile computer of the first user.

14. The system of claim 13, wherein the processing unit is further configured for
receiving, via the communications network, a definition of a sales milestone from an administrator, and wherein the aggregate data transmitted to the mobile computer of the first user includes a proximity of the cumulative sales of the first user to the sales milestone.

15. The system of claim 14, wherein sales transaction data includes at least one or more product identifiers, buyer contact information and electronic payment information.

16. The system of claim 15, wherein recruit enrollment data includes a description of communication activity with the second user, including a log of telephone calls to the second user.

17. The system of claim 16, wherein aggregate data pertaining to sales effectuated by the first user comprises cumulative sales effectuated by the first user.

18. The system of claim 17, wherein aggregate data pertaining to sales effectuated by recruits of the first user comprises cumulative sales effectuated by recruits of the first user.

19. The system of claim 13, wherein the step of transmitting further comprises:
transmitting the aggregate data to the mobile computer of the first user via the communications network using a push service.

20. The method of claim 13, wherein the central server is further configured for:
generating commission information of the first user based on the sales effectuated by the first user and the sales effectuated by recruits of the first user; and
transmitting the commission data to the mobile computer of the first user via the communications network.
